(19) United States
(12) Patent Application Publication
(10) Pub. No.: US 2009/0106754 A1
(43) Pub. Date: Apr. 23, 2009

(54) Handling a device related operation in a virtualization enviroment

(76) Inventors: Benjamin Liu, Shanghai (CN); Yunhong Jiang, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/576,961

(22) PCT Filed: Dec. 10, 2005
(86) PCT No.: PCT/CN2005/002149

§ 371 Date: Apr. 20, 2006

(51) Int. Cl. G06F 9/46

(52) U.S. Cl. 718/1

(57) ABSTRACT

Methods, system and machine-readable medium are described to handle a device related operation in a virtualization environment. In some embodiment, a kernel component of a virtual machine monitor may determine that a device related operation happens in a virtual machine through a operation transition from the virtual machine to the kernel component; and may determine whether the device related operation can be handled by a first virtual hardware device installed inside of the kernel component of the virtual machine monitor. In other embodiment, the kernel components may initiate an interrupt by the first virtual hardware device; and inject the interrupt from the first virtual hardware device to the virtual machine through another operation transition from the kernel component to the virtual machine.

This U.S. Patent application claims priority to PCT/CN2005/002149 filed in China Dec. 10, 2005.

### BACKGROUND

A virtual machine architecture logically partitions a physical machine, such that the underlying hardware of the machine is time-shared and appears as one or more independently operation virtual machines. A virtual machine monitor (VMM) creates the virtual machine and runs on a computer to facilitate for other software the abstraction of one or more virtual machines. The virtual machine monitor may further facilitate communication between the virtual machine and a device model that may be virtualization/simulation of a real device. Examples for the virtual machine monitor may comprise a hybrid virtual machine monitor, a host virtual machine monitor and a hypervisor virtual machine monitor. Examples for the real device may comprise input/output (I/O) device, interrupt controller, event timer, etc.

In some embodiments, the virtual machine monitor may comprise a kernel component (e.g., hypervisor) to provide virtualization service for processor(s), memory, etc. The kernel component may further manage propagation of an operation related to the device model, such as an input/output operation from/to the device model and an interrupt propagation initiated by the device model. However, such an operation is ultimately handled within the device model. For example, the device model may output a data to the virtual machine in response to an I/O request routed by the virtual machine monitor. For another example, the device model may initiate an interrupt and inject the interrupt to the virtual machine propagated through the virtual machine monitor.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing platform incorporating a hybrid virtual machine monitor.

FIG. 2 illustrates an embodiment of a method of handling an input/output operation in a virtualization environment created by the hybrid virtual machine monitor of FIG. 1.

FIG. 3 illustrates an embodiment of a method of handling an interrupt operation in the virtualization environment created by the hybrid virtual machine monitor of FIG. 1.

FIG. 4 illustrates an embodiment of a method of installing a virtual device into the hybrid virtual machine monitor of FIG. 1.

FIG. 5 illustrates another embodiment of a computing platform incorporating a host virtual machine monitor.

### DETAILED DESCRIPTION OF THE PREFERRED EMBODIMENTS

The following description describes techniques for handling a device related operation in a virtualization environment created by a virtual machine monitor. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

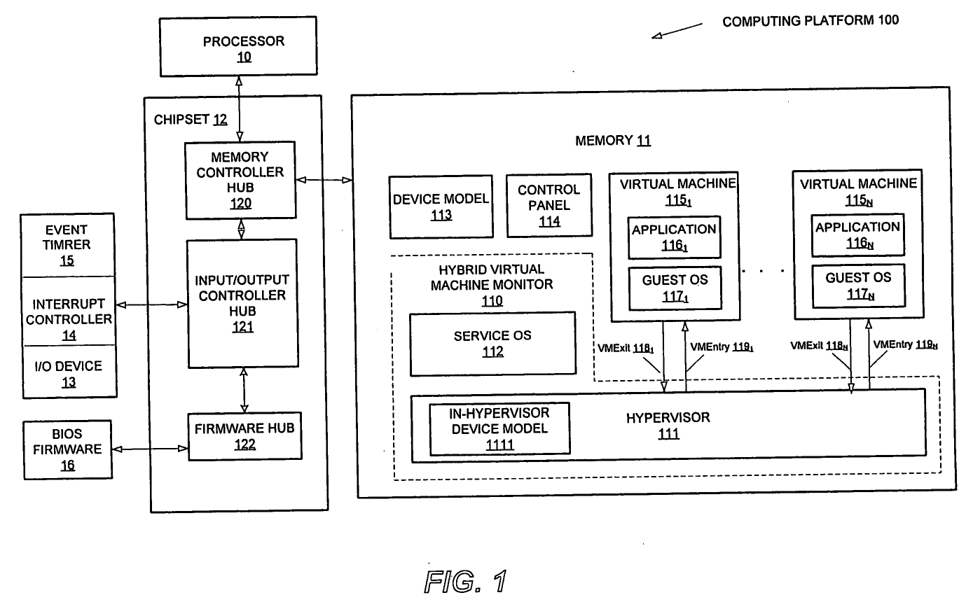

FIG. 1 shows an embodiment of a computing platform incorporating a hybrid virtual machine monitor. A non-exhaustive list of examples for the computing system may include distributed computing systems, supercomputers, computing clusters, mainframe computers, mini-computers, personal computers, workstations, servers, portable computers, laptop computers and other devices for transceiving and processing data.

In an embodiment, the computing system 1 may comprise one or more processors 10, memory 11, chipset 12, I/O device 13, interrupt controller 14, event timer 15, BIOS firmware 16 and the like. The one or more processors 10 are communicatively coupled to various components (e.g., the memory 11) via one or more buses such as a processor bus. The processors 10 may be implemented as an integrated circuit (IC) with one or more processing cores that may execute codes under a suitable architecture, for example, including Intel® Xeon™, Intel® Pentium™, Intel® Itanium™ architectures, available from Intel Corporation of Santa Clara, Calif.

In an embodiment, the memory 11 may store codes to be executed by the processor 10. A non-exhaustive list of examples for the memory 102 may comprise one or a combination of the following semiconductor devices, such as synchronous dynamic random access memory (SDRAM) devices, RAMBUS dynamic random access memory (RDRAM) devices, double data rate (DDR) memory devices, static random access memory (SRAM), flash memory devices, and the like.

In an embodiment, the chipset 12 may provide one or more communicative paths among the processor 10, memory 11 and various components, such as the I/O device 13, interrupt controller 14, event timer 15 and BIOS firmware 16. The chipset 12 may comprise a memory controller hub 120, an input/output controller hub 121 and a firmware hub 122.

In an embodiment, the memory controller hub 120 may provide a communication link to the processor bus that may connect with the processor 101 and to a suitable device such as the memory 11. The memory controller hub 120 may couple with the I/O controller hub 121, that may provide an interface to the I/O devices 13, interrupt controller 14, event timer 15, and other components. A non-exhaustive list of examples for the I/O devices 13 may comprise a keyboard, mouse, video device, audio device, network card, a storage device, a camera, a Bluetooth® transceiver, an antenna, and the like. Example for the interrupt controller 14 may comprise a programmable interrupt controller (PIC). Example for the event timer 15 may comprise a programmable interval timer (PIT).

In an embodiment, the memory controller hub 120 may communicatively couple with a firmware hub 122 via the input/output controller hub 121. The firmware hub 122 may couple with the BIOS firmware 16 that may store routines that the computing device 100 executes during system startup in order to initialize the processors 10, chipset 12, and other components of the computing device 1. Moreover, the BIOS firmware 16 may comprise routines or drivers that the computing device 1 may execute to communicate with one or more components of the computing device 1.

In an embodiment, the memory 11 may store software images such as a hybrid virtual machine monitor 110, device model 113 and control panel 114. The memory 11 may further store a plurality of guest software images running on a plurality of virtual machines created and managed by the hybrid virtual machine monitor 110, such as application 116₁ and guest operating system 117₁ running on a virtual machine 115₁, and application 116_{N} and guest operating system 117_{N} running on a virtual machine 115_{N}. The hybrid virtual machine monitor 110 may comprise various components.

In an embodiment, the hybrid virtual machine monitor 110 may further comprise a hypervisor 111 as a kernel component and a service operating system 112. The hypervisor 111 may be responsible for processor/memory resource virtualization and domain scheduling. The hypervisor 111 may further manage propagation of an operation related to the device model 113, such as propagation/routing an I/O operation from/to the device model 113 and an interrupt propagation initiated by the device model 113. The service operating system 112 may be responsible for device virtualization/simulation through working with the device model 113 and virtual machine management through working with the control panel 114. The device model 113 may be a virtual device that may be created or defined for example according to the hybrid virtual machine monitor architecture.

In some embodiments, the device model 113 may not be connected to or represented by a real instance of a device, and may not be reflected in a real device that is connected to a hardware component. Examples for the device model 113 may comprise, but not limited to, virtual input/output device (e.g., a virtual keyboard, a virtual mouse, a virtual storage device, a virtual video device, a virtual audio device, etc.), virtual programmable internal timer, or virtual event timer, etc. The control panel 114 may be a user interface that may provide BIOS interface and data to the service operating system 112. The service operating system 112 and the control panel 114 may manage configurations for real resources (e.g., processor 10, memory 11, I/O device 13, interrupt controller 14, event timer 15, BIOS firmware 16, etc.) as well as virtual resources that a virtual machine 115₁-115_{N} can see, wherein the service operating system 112 may manage the real resources and the control panel 114 may manage the virtual resources.

The virtual machine 115₁-115_{N} may provide a virtualization platform for guest software images, such as guest operating systems 117₁-117_{N} and guest software applications 116₁-116_{N}, wherein the guest operating systems 117₁-117_{N} may be different from the service operating system 112.

In an embodiment, the hypervisor 111 may be further installed with software images as an in-hypervisor device model 1111 that may be a virtual device created or defined for example according to the hybrid virtual machine monitor architecture. The in-hypervisor device model 1111 may not be connected to or represented by a real instance of a device, and may not be reflected in a real device that is connected to a hardware component. Examples for the in-hypervisor device model 1111 may comprise, but not limited to, virtual input/output device (e.g., a virtual keyboard, a virtual mouse, a virtual storage device, a virtual video device, a virtual audio device, etc.), virtual programmable internal timer, virtual event timer, etc.

In an embodiment, the in-hypervisor device model 1111 may be different from device model 113. In another embodiment, the in-hypervisor device model 1111 may be frequently used by the virtual machine 115₁-115_{N}. For example, the in-hypervisor device model 1111 may be a virtual device frequently used for data input/output to/from the virtual machine 115₁-115_{N}, such as a virtual keyboard, virtual mouse, virtual video device, virtual audio device, etc, or may be a virtual device frequently used for interrupt injection to the virtual machine 115₁-115_{N}, such as a virtual programmable interval timer (PIT), a virtual programmable interrupt controller (PIC), etc.

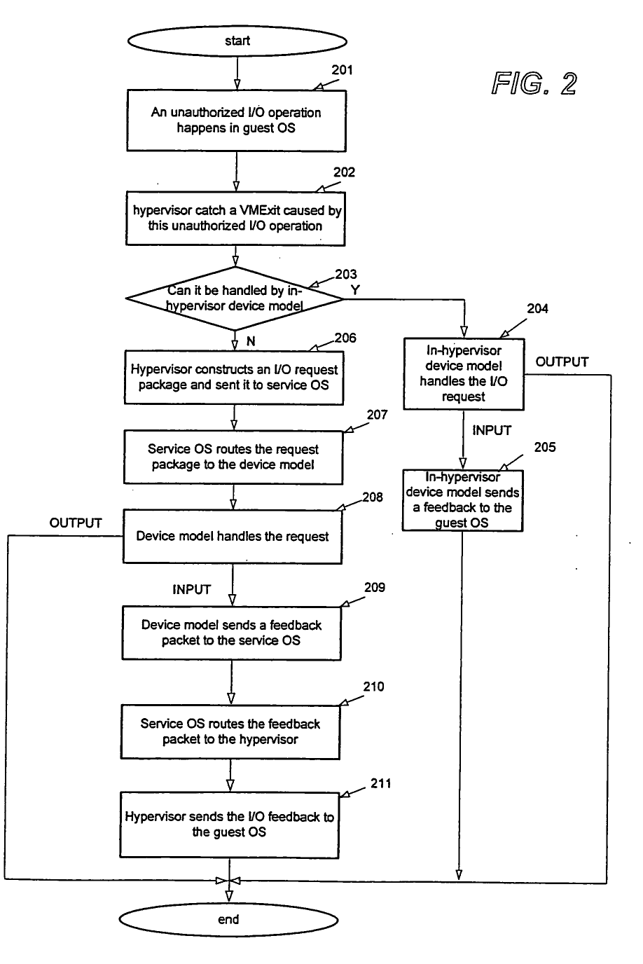

FIG. 2 shows an embodiment of a method of vitalizing an input/output operation in a virtualization environment created by the hybrid virtual machine monitor 110 of FIG. 1.

In the embodiment, an unauthorized I/O operation for inputting a data from a device (input operation) or outputting a data to the device (output operation) happens in a guest operating system running on a virtual machine (e.g., guest operating system 117₁ running on the virtual machine 115₁), and a corresponding device driver in the guest operating system may execute an ‘IN’ instruction (for input operation)/‘OUT’ instruction (for output instruction) that may cause a trap into the hypervisor 111 in block 201, because the guest operating system is deprivileged.

In block 202, the hypervisor 111 may perceive the unauthorized I/O operation happened in the guest operating system through a virtual machine exit (e.g., VMExit 118₁), which is a transition from non-root VMX operation in the virtual machine to root VMX operation in the hypervisor 111. In block 203, upon perceiving the I/O operation, the hypervisor 111 may determine whether the I/O operation can be handled by the in-hypervisor device model 1111. In an embodiment, if the in-hypervisor device model 1111 comprises a virtual device related to the I/O operation, then the hypervisor 111 may determine that the I/O operation may be handled by the in-hypervisor device model 1111. For example, if the I/O operation related to a keyboard and the in-hypervisor device model 1111 comprises a virtual keyboard, then the hypervisor 111 may determine that the I/O operation can be handled by the in-hypervisor device model 1111. For another example, if the I/O operation related to a programmable interval timer (PIT) and the in-hypervisor device model 1111 comprises a virtual PIT, then the hypervisor 111 may determine that the I/O operation can be handled by the in-hypervisor device model 1111.

In response to determining that the in-hypervisor device model 1111 can handle the I/O operation, the in-hypervisor device model 1111 may handle it in block 204. For output operation, the data from the guest operating system may be output to the in-hypervisor device model 1111. However, for input operation, the in-hypervisor device model 1111 may obtain a data through cooperating with the service operating system 112 and underlying hardware of the computer platform 100, and send the data as an I/O feedback to the guest operating system through a virtual machine entry (e.g., VMEntry 119₁), which is another transition from the root VMX operation in the hypervisor 111 to the non-root VMX operation in the virtual machine (block 205).

In response to determining that the in-hypervisor device model 1111 can not handle the I/O operation, the hypervisor 111 may construct an I/O request packet and send the packet to the service operating system 112 (block 206). Then, in block 207, the service operating system 112 may route the I/O request packet to the device model 113 that may comprise a virtual device related to the I/O operation. In block 208, the device model 113 may handle the I/O request. For output operation, the data from the guest operating system may be output to the device model 113. However, for input operation, the device model 113 may obtain a data through cooperating with the service operating system 112 and underlying hardware of the computer platform 100, and send a feedback packet incorporating the data to the service OS 112 (block 209) that may further route the feedback packet to the hypervisor 111 (block 210). In block 211, the hypervisor 111 may provide the guest operating system with the data as an I/O feedback through the virtual machine entry.

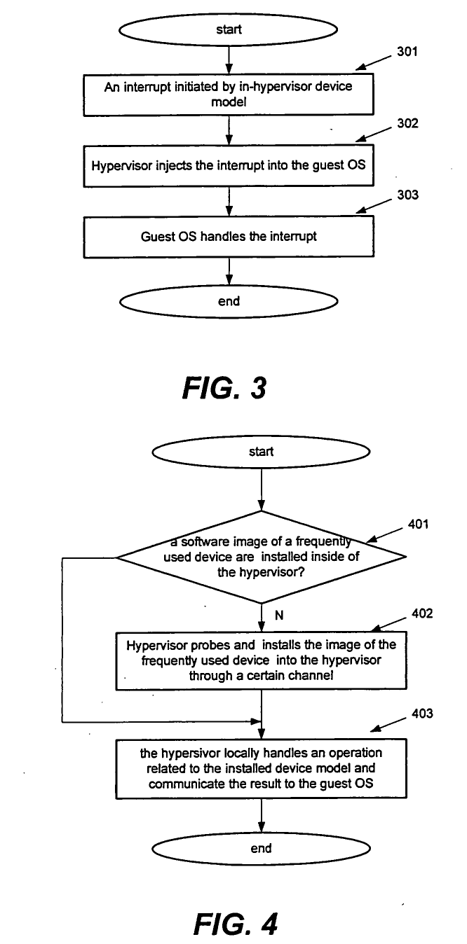

FIG. 3 illustrates an embodiment of a method of virtualizing an interrupt operation in the virtualization environment.

The in-hypervisor device model 1111 may initiate an interrupt for a guest operating system (e.g., guest operating system 117₁) (block 301), and injects the interrupt into the guest operating system (block 302) so that the guest operating system may handle the interrupt (block 303). In an embodiment, if the in-hypervisor device model 1111 is a virtual PIT (e.g., a virtual device corresponding to a timer device i8254), once timeout happens, the virtual PIT may initiate a timer interrupt for the guest operating system and inject the timer interrupt into the guest operating system by a stack tweak or VMEntry's interrupt injection.

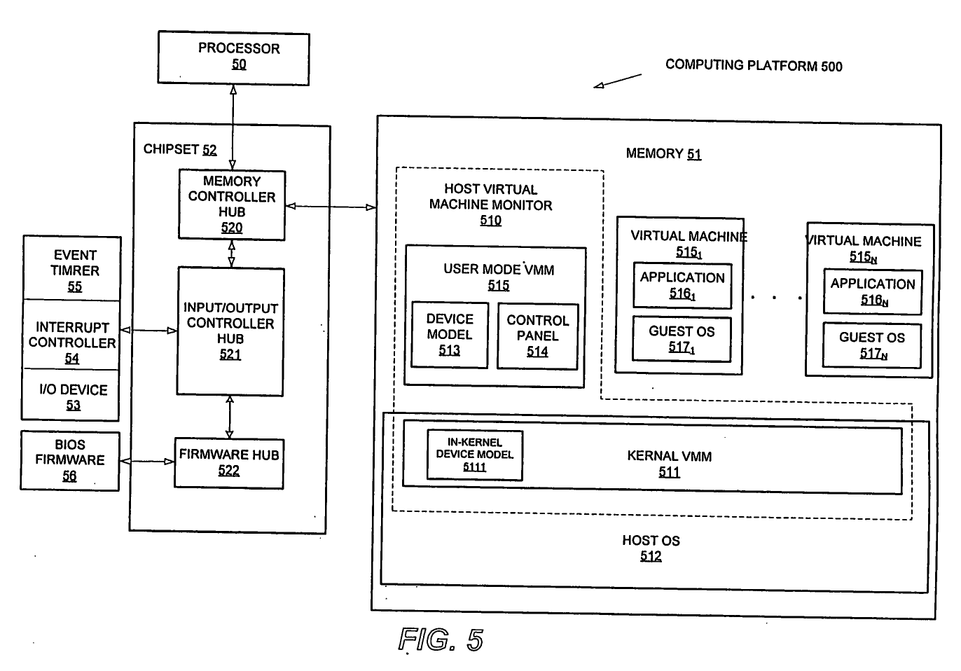

FIG. 4 shows an embodiment of installing an image of a virtual device into the hybrid virtual machine monitor.

In block 401, the hypervisor 111 or an operator may determine whether a software image for a frequently used device is installed inside of the hypervisor 111. In an embodiment, the device may be an I/O device that may be frequently used to input/output data from/to a virtual machine. In another embodiment, the device may be a time device that may be frequently used to initiate an interrupt into the virtual machine.

In block 402, the hypervisor 111 or the operator may probe and install the image of the frequently used device inside of the hypervisor 111 as the in-hypervisor device model 1111, in response to determining that the image has not been installed inside of the hypervisor 111 yet. The image may be obtained through a certain channel, for example, a network, service OS, hypervisor boot-time model, etc.

In block 403, the in-hypervisor device model 1111 may locally handle an operation related to the frequently used device and communicate the result to the virtual machine or other devices of the computing platform.

Another embodiment of a computer platform incorporating a host virtual machine monitor is depicted in FIG. 5.

As depicted, the memory 51 of the computer platform 500 may store software images as a host virtual machine monitor 510 and a host operating system 512. The memory 51 may further store a plurality of guest software images running on a plurality of virtual machines created and managed by the host virtual machine monitor 510, such as application 516₁ and guest operating system 517₁ running on a virtual machine 515₁ and application 516_{N} and guest operating system 517_{N} running on a virtual machine 515_{N}.

The host virtual machine monitor 510 may comprise various components, such as a kernel virtual machine monitor 511 and user mode virtual machine monitor 515. The kernel virtual machine monitor 511 may monitor some system/privileged information which guest application 516₁-516_{N} can't get from system call. Because hosted virtual machine monitor has its big chunk in user application space, it may need some hooks in kernel virtual machine monitor 511 to fetch system information, for example, interrupt or I/O operation, etc. The user mode virtual machine monitor 515 may be responsible for device virtualization/simulation, processor/memory virtualization/simulation, and virtual machine scheduling. The user model virtual machine monitor 515 may comprise a device model 513 that may be a virtual device created or defined according to the host virtual machine monitor architecture, and a control panel 514 that may be useful to manage the virtual machine 515₁-515_{N}.

In an embodiment, the kernel virtual machine monitor 511 may be further installed with software images as an in-kernel device model 5111 that may be another virtual device created or defined according to the host virtual machine monitor architecture, such as virtual I/O device, virtual interrupt controller or virtual event timer. The in-kernel device model 5111 may be different from the device model 513 and may be frequently used by the virtual machine 515₁-515_{N}.

The kernel virtual machine monitor 511 may perceive an unauthorized I/O operation related to an I/O device happened in a guest operating system of a virtual machine and determine whether the I/O operation can be handled by the in-kernel device model 5111. If can, the in-kernel device model 5111 may handle the operation. If can not, the kernel virtual machine monitor 511 may pass the I/O operation to the device model 513.

In another embodiment, the in-kernel device model 5111 may be installed inside of the host operating system 512 but outside of the kernel virtual machine monitor 511.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method, comprising
determining that a device related operation happens in a virtual machine by a kernel component of a virtual machine monitor through an operation transition from the virtual machine to the kernel component; and
determining whether the device related operation can be handled by a first virtual input/output device installed inside of the kernel component of the virtual machine monitor.

2. The method of claim 1, wherein the first virtual input/output device comprise at least one of virtual keyboard, virtual mouse, virtual audio device, virtual video device.

3. The method of claim 1, wherein the virtual machine monitor is a hybrid virtual machine monitor.

4. The method of claim 3, wherein the kernel component is a hypervisor of the hybrid virtual machine monitor.

5. The method of claim 1, wherein the virtual machine monitor is a host virtual machine monitor.

6. The method of claim 5, wherein the kernel component is an in-kernel virtual machine monitor of a host operating system.

7. The method of claim 1, further comprising:
passing the device related operation to a second virtual input/output device installed outside of the kernel component of the virtual machine monitor, in response to determining that the device related operation can not be handled by the first virtual input/output device.

8. The method of claim 1, further comprising:
initiating an interrupt by the first virtual input/output device; and
injecting the interrupt from the first virtual input/output device to the virtual machine through another operation transition from the kernel component to the virtual machine.

9. A virtual machine monitor, comprising a kernel component to determine that a device related operation happens in a virtual machine through an operation transition from the virtual machine to the kernel component, wherein the kernel component further comprises a first virtual input/output device.

10. The virtual machine monitor of claim 9, wherein the first virtual input/output device comprise at least one of a virtual keyboard, virtual mouse, virtual audio device and virtual video device.

11. The virtual machine monitor of claim 9, wherein the virtual machine monitor is a hybrid virtual machine monitor.

12. The virtual machine monitor of claim 11, wherein the kernel component is a hypervisor of the hybrid virtual machine monitor.

13. The virtual machine monitor of claim 9, wherein the virtual machine monitor is a host virtual machine monitor.

14. The virtual machine monitor of claim 13, wherein the kernel component is an in-kernel virtual machine monitor of a host operating system.

15. The virtual machine monitor of claim 9, further comprising:
a second virtual input/output device installed outside of the kernel component of the virtual machine monitor to handle the device related operation in response to determining that the device related operation can not be handled by the first virtual input/output device.

16. The virtual machine monitor 9, wherein the first virtual input/output device is further to initiate an interrupt and inject the interrupt from the first virtual input/output device to the virtual machine through another operation transition from the kernel component to the virtual machine.

17. A machine-readable medium comprising a plurality of instructions which when executed result in an apparatus:
determining that a device related operation happens in a virtual machine by a kernel component of a virtual machine monitor through an operation transition from the virtual machine to the kernel component;
determining whether the device related operation can be handled by a first virtual hardware device installed inside of the kernel component of the virtual machine monitor; and
passing the device related operation to a second virtual hardware device installed outside of the kernel component of the virtual machine monitor, in response to determining that the device related operation can not be handled by the first virtual hardware device.

18. The machine-readable medium of claim 17, wherein the first virtual hardware device comprises at least one of virtual input/output device, virtual interrupt controller, and virtual event timer.

19. The machine-readable medium of claim 17, wherein the second virtual hardware device comprise at least one of virtual input/output device, virtual interrupt controller, and virtual event timer.

20. The machine-readable medium of claim 17, wherein the virtual machine monitor is a hybrid virtual machine monitor.

21. The machine-readable medium of claim 17, wherein the kernel component is a hypervisor of the hybrid virtual machine monitor.

22. The machine-readable medium of claim 17, wherein the virtual machine monitor is a host virtual machine monitor.

23. The machine-readable medium of claim 17, wherein the kernel component is an in-kernel virtual machine monitor of a host operating system.

24. The machine-readable medium of claim 17, wherein the plurality of instructions further result in the apparatus:
initiating an interrupt by the first virtual hardware device; and
injecting the interrupt from the first virtual hardware device to the virtual machine through another operation transition from the kernel component to the virtual machine.
